(19) United States
(12) Patent Application Publication
(10) Pub. No.: US 2016/0099645 A1
(43) Pub. Date: Apr. 7, 2016

(54) VOLTAGE REGULATOR

(71) Applicant: Seiko Instruments Inc., Chiba-shi (JP)

(72) Inventors: Manabu FUJIMURA, Chiba-shi (JP); Minoru SUDO, Chiba-shi (JP)

(21) Appl. No.: 14/968,062

(22) Filed: Dec. 14, 2015

Related U.S. Application Data
(63) Continuation of application No. PCT/JP2014/064266, filed on May 29, 2014.

(30) Foreign Application Priority Data
Jun. 19, 2013 (JP) 2013-128906

(51) Int. Cl. H02M 3/158

(52) U.S. Cl. CPC H02M 3/158

(57) ABSTRACT

To provide a voltage regulator capable of using as a capacitor of a phase compensation circuit, a capacitor large in capacitance value per unit area and thin in oxidation film thickness. A voltage limitation circuit that limits so that a voltage applied across a capacitor of a phase compensation circuit does not reach a predetermined value or greater is provided in parallel with the capacitor.

### RELATED APPLICATIONS

The present application is a continuation of International Application PCT/JP2014/064266, with an international filing date of May 29, 2014, which claims priority to Japanese Patent Application No. 2013-128906 filed on Jun. 19, 2013, the entire contents of which are incorporated herein by reference.

### BACKGROUND OF THE INVENTION

1. Field of the Invention

The present invention relates to a voltage regulator, and more specifically to a reduction in the size of a phase compensation circuit.

2. Background Art

FIG. 2 is a related art voltage regulator equipped with a phase compensation circuit.

A voltage divider circuit 106 divides an output voltage V_{OUT} of the voltage regulator to output a feedback voltage V_{FB}. A differential amplifier circuit 104 amplifies a difference between a reference voltage V_{REF} of a reference voltage circuit 103 and the feedback voltage V_{FB}. A source-grounded amplifier circuit configured by a MOS transistor 107 that serves as a second amplifying circuit amplifies an output thereof to control a gate-source voltage of an output transistor 105. The phase compensation circuit composed of a resistor 108 and a capacitor 109 is connected between a gate and drain of the MOS transistor 107.

When the output voltage V_{OUT} is low, i.e., the feedback voltage V_{FB} is lower than the reference voltage V_{REF}, the output of the differential amplifier circuit 104 becomes a high voltage so that the MOS transistor 107 goes OFF. The output transistor 105 goes ON because its gate-source voltage becomes large, and controls the output voltage V_{OUT} so as to be high.

When the output voltage V_{OUT} is high, i.e., the feedback voltage V_{FB} is larger than the reference voltage V_{REF}, the output of the differential amplifier circuit 104 becomes a low voltage so that the MOS transistor 107 goes ON. The output transistor 105 goes OFF because its gate-source voltage becomes low, and controls the output voltage V_{OUT} so as to be low.

Generally, there is a need to broaden a frequency band for the purpose of improving the response of a voltage regulator. The related art voltage regulator takes a configuration of a voltage three-stage amplifier circuit in entirety in conjunction with a source-grounded amplifier circuit composed of the output transistor 105. The voltage three-stage amplifier circuit is added with a phase compensation circuit since it is likely to be delayed 180° or more in phase (refer to, for example, Japanese Unexamined Patent Application Publication No. 2004-62374).

In the related art voltage regulator, however, when the gate capacity of the output transistor 105 is large, the capacitance value of the capacitor 109 of the phase compensation circuit needs to have a magnitude equal to or greater than the capacitance value of the gate of the output transistor 105 to ensure stability for oscillation.

Further, when a power supply voltage is operated at a high voltage, the capacitor 109 is applied with a high voltage thereacross in a state in which the output of the differential amplifier circuit 104 becomes a maximum or minimum voltage, during an operation other than a steady state of the voltage regulator. Accordingly, the capacitor 109 needs to be set to a high breakdown capacitor in order to prevent an oxide film from being broken.

Since the high breakdown capacitor is thick in oxide film thickness, the capacitance value per unit area is very small. Thus, the area is required to be increased for the purpose of enlarging the capacitance value. Accordingly, a problem arises in that a chip area increases, thereby leading to an increase in cost.

### SUMMARY OF THE INVENTION

In order to solve the above problems, a voltage regulator of the present invention is provided in parallel with a capacitor of a phase compensation circuit, with a voltage limitation circuit that limits so that a voltage applied across the capacitor does not reach a predetermined value or greater.

According to the voltage regulator of the present invention, a capacitor large in capacitance value per unit area and thin in oxide film thickness can be used as the capacitor of the phase compensation circuit, thereby making it possible to reduce a chip area.

### BRIEF DESCRIPTION OF THE DRAWINGS

FIG. 1 is a circuit diagram showing a voltage regulator according to an embodiment of the present invention; and

FIG. 2 is a circuit diagram showing a related art voltage regulator.

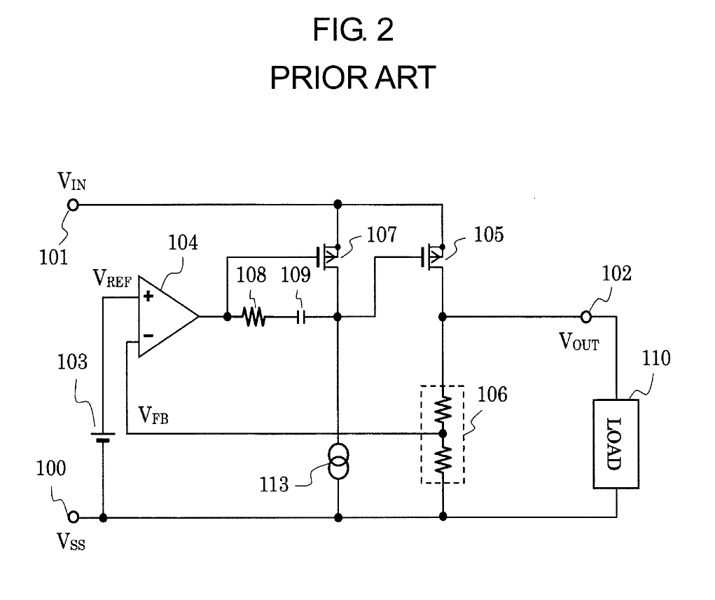

### DETAILED DESCRIPTION OF THE PREFERRED EMBODIMENTS

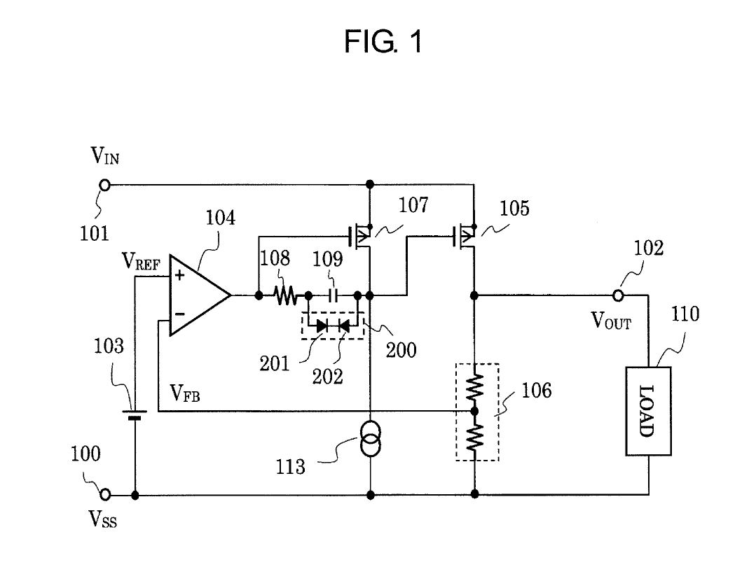

FIG. 1 is a circuit diagram showing a voltage regulator according to an embodiment of the present invention.

The voltage regulator according to the present embodiment includes a reference voltage circuit 103, a differential amplifier circuit 104, a MOS transistor 107, a constant current source 113, a resistor 108 and a capacitor 109 that serve as a phase compensation circuit, a voltage divider circuit 106, an output transistor 105, and a voltage limitation circuit 200. The voltage limitation circuit 200 is composed of diodes 201 and 202.

A description will next be made of connections of the voltage regulator.

The reference voltage circuit 103 has an output terminal connected to a non-inverting input terminal of the differential amplifier circuit 104. The output transistor 105 is provided between a power supply terminal 101 and an output terminal 102. The voltage divider circuit 106 is provided between the output terminal 102 and a ground terminal 100 and has an output terminal connected to an inverting input terminal of the differential amplifier circuit 104. The differential amplifier circuit 104 is connected to a gate of the MOS transistor 107. The MOS transistor 107 and the constant current source 113 that form a source-grounded amplifier circuit are connected in series between the power supply terminal 101 and the ground terminal 100 and respectively have an output terminal connected to a gate of the output transistor 105. The phase compensation circuit formed by the resistor 108 and capacitor 109 connected in series is connected between the gate and drain of the MOS transistor 107. The voltage limitation circuit 200 has diodes 201 and 202 of which the cathodes are connected to each other and the anodes are connected across the capacitor 109.

The operation of the voltage regulator will next be described.

The voltage divider circuit 106 divides an output voltage V_{OUT} of the output terminal 102 of the voltage regulator to output a feedback voltage V_{FB}. The differential amplifier circuit 104 amplifies a difference between a reference voltage V_{REF} of the reference voltage circuit 103 and the feedback voltage V_{FB}. The source-grounded amplifier circuit configured by the MOS transistor 107 and the constant current source 113 that serve as a second amplifier circuit amplifies the output voltage of the differential amplifier circuit 104 to control a gate-source voltage of the output transistor 105.

When the feedback voltage V_{FB} is smaller than the reference voltage V_{REF}, the output of the differential amplifier circuit 104 becomes a high voltage near a power supply voltage V_{IN}. Since the MOS transistor 107 is brought to an OFF state, the voltage of its drain is reduced to near a ground voltage V_{SS} by the constant current source 113. Thus, the capacitor 109 of the phase compensation circuit becomes a maximum voltage applied thereacross.

Here, the diode 202 of the voltage limitation circuit 200 limits with a reverse voltage so that the voltage applied across the capacitor 109 does not reach a predetermined value or greater.

Further, when the feedback voltage V_{FB} is larger than the reference voltage V_{REF}, the output of the differential amplifier circuit 104 becomes a low voltage near the ground voltage Vss. Since the MOS transistor 107 is brought to an ON state, the voltage of its drain is raised to a high voltage near the power supply voltage V_{IN}.

Here, the diode 201 of the voltage limitation circuit 200 limits with a reverse voltage so that a potential difference generated across the capacitor 109 does not reach the predetermined value or greater.

As described above, the voltage regulator according to the present embodiment has been equipped with the voltage limitation circuit 200. It is therefore possible to limit the voltage applied across the capacitor 109 of the phase compensation circuit not to be the predetermined value or greater even when the output of the differential amplifier circuit 104 becomes the maximum or minimum voltage. Accordingly, the area occupied by the capacitor can be greatly reduced, thereby making it possible to reduce a chip area.

Incidentally, in the description of the present embodiment, the voltage limitation circuit 200 has been explained by taking, for example, the diodes 201 and 202 of which the cathodes are connected to each other. Any circuit may however be adopted if being capable of limiting the voltage applied across the capacitor 109 so as not to be the predetermined value or greater. The present invention is not limited thereto.

What is claimed is:

1. A voltage regulator comprising:
a differential amplifier circuit that is inputted with a reference voltage and a feedback voltage obtained by dividing an output voltage of the voltage regulator and outputs a control voltage obtained by amplifying a difference between the reference voltage and the feedback voltage;
a source-grounded amplifier circuit that has an input terminal to which an output terminal of the differential amplifier circuit is connected and amplifies the control voltage;
a phase compensation circuit provided between the input terminal of the source-grounded amplifier circuit and an output terminal thereof;
an output transistor that has a gate to which the output terminal of the source-grounded amplifier circuit is connected and controls the output voltage of the voltage regulator; and
a voltage limitation circuit that is connected in parallel with a capacitor configuring the phase compensation circuit and controls a voltage applied across the capacitor so as not to be a predetermined voltage or greater.

2. The voltage regulator according to claim 1, wherein the voltage limitation circuit is equipped with a first voltage limiting circuit that imposes a limitation when a voltage of the capacitor on the input terminal side of the source-grounded amplifier circuit becomes high, and a second voltage limiting circuit that imposes a limitation when a voltage of the capacitor on the output terminal side of the source-grounded amplifier circuit becomes high.

3. The voltage regulator according to claim 2, wherein the first voltage limiting circuit and the second voltage limiting circuit are diodes respectively.
